(19) United States
(12) Patent Application Publication
(10) Pub. No.: US 2017/0345229 A1
(43) Pub. Date: Nov. 30, 2017

(54) Systems and Methods For Data Acquisition From A Remote System

(71) Applicant: GM GLOBAL TECHNOLOGY OPERATIONS LLC, Detroit, MI (US)

(72) Inventors: Xiaoyu Huang, Troy, MI (US); Youssef A. Ghoneim, Rochester, MI (US)

(21) Appl. No.: 15/166,756

(22) Filed: May 27, 2016

(51) Int. Cl. G07C 5/00; B60T 17/22

(52) U.S. Cl. CPC G07C 5/008; B60T 17/22

(57) ABSTRACT

A vehicle includes a brake system configured to resist vehicle movement. The vehicle also includes at least one controller in communication with the brake system. The controller is programmed to detect an initiation of a braking event and monitor raw signal data associated with the brake system during the braking event. The controller is also programmed to generate a feature data set based on the raw signal data that is indicative of performance of at least one component of the brake system. The controller is further programmed to identify a vehicle maneuver class based on a rate of change of vehicle movement, store the feature data set and the identified vehicle maneuver class as a data vector, and transmit the data vector to a processor.

### TECHNICAL FIELD

The present disclosure relates to data acquisition from a remote vehicle.

### INTRODUCTION

Vehicles that operate a combination of different subsystems may generate large amounts of data. Large scale processing and analysis of the data may be performed by a more powerful computing processor that remote from the vehicle itself. Additionally, data from a plurality of vehicles may be compiled to generate trends and assess the performance of various subsystems. Transfer of significant amounts of subsystem data from one or more vehicles to an off-board computing system may be time consuming and/or expensive.

### SUMMARY

A vehicle includes a brake system configured to resist vehicle movement. The vehicle also includes at least one controller in communication with the brake system. The controller is programmed to detect an initiation of a braking event and monitor raw signal data associated with the brake system during the braking event. The controller is also programmed to generate a feature data set based on the raw signal data that is indicative of performance of at least one component of the brake system. The controller is further programmed to identify a vehicle maneuver class based on a rate of change of vehicle movement, store the feature data set and the identified vehicle maneuver class as a data vector, and transmit the data vector to a processor.

A method of transmitting vehicle data includes monitoring raw signal data from at least one vehicle component in response to detecting an initiation of a driving maneuver. The method also includes generating a feature data set based on the raw signal data that is indicative of performance of the at least one vehicle component during the driving maneuver. The method further includes identifying a vehicle maneuver class based on a rate of change of vehicle movement. The method further includes storing the feature data set and the identified vehicle maneuver class as a data vector, and transmitting the data vector to an off-board processor.

A data acquisition system includes an off-board server, and an on-board controller in communication with the server and at least one on-board component. The controller is programmed to detect an initiation of a performance event and monitor raw signal data associated with the at least one component during the performance event. The controller is also programmed to generate a feature data set based on the raw signal data that is indicative of performance of the at least one component and identify a performance event class based on a performance attribute. The controller is further programmed to store the feature data set and the identified performance event class as a data vector, and transmit the data vector to the off-board server.

### BRIEF DESCRIPTION OF THE DRAWINGS

FIG. 1 is a schematic diagram of vehicle data acquisition system.

FIG. 2 is an example plot of speed and acceleration for a drive cycle.

FIG. 3 is a flowchart of a method of data acquisition for a vehicle braking event.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

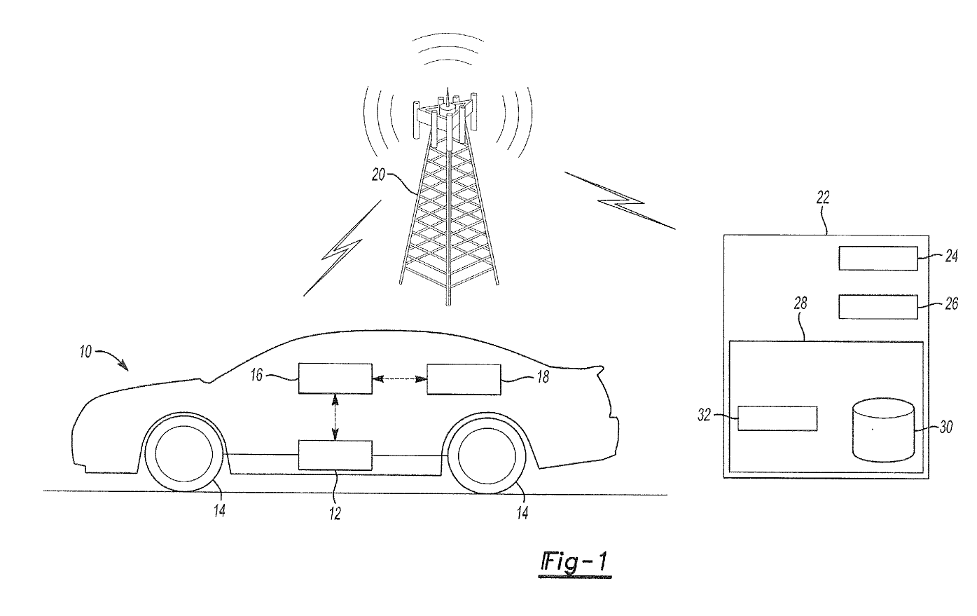

Referring to FIG. 1 a vehicle 10 includes a brake system 12 configured to inhibit vehicle movement by applying a resistive torque to at least one vehicle wheel 14. The brake system 12 may include a friction brake disposed at the wheel 14 which engages a rotor portion that rotates with the wheel 14. The brake system 12 may be hydraulically driven such that changes in fluid pressure within the hydraulic brake line actuate the friction brake at the vehicle wheel. When deceleration is desired, a deceleration demand signal is provided to activate the brake system 12. The deceleration demand signal may be generated based on a driver input such as depressing a brake pedal. Alternatively, braking demand may be automatically determined by an on-board processor, an off-board processor, or a cooperation between processors at different locations. The processor may calculate a need for deceleration, then automatically cause activation of the brake system 12 to slow the vehicle 10. For example, in the case of a self-driving autonomous vehicle, driver input may not be required to actively control propulsion and deceleration of the vehicle.

A controller 16 is provided to monitor and control operation of the brake system 12. The controller 16 includes one or more digital computers each having a microprocessor or central processing unit (CPU), read only memory (ROM), random access memory (RAM), electrically-programmable read only memory (EPROM), a high speed clock, analog-to-digital (A/D) and digital-to-analog (D/A) circuitry, input/output circuitry and devices (I/O), as well as appropriate signal conditioning and buffering circuitry. The controller 16 may also store a number of algorithms or computer executable instructions needed to issue commands to perform actions according to the present disclosure.

The controller 16 also monitors a number of signals from various sensors and components which are indicative of vehicle operation. For example, a sensor may be provided near a brake pedal (not shown) and may output signals indicative of the position of a brake pedal and/or the pressure applied to the pedal by a driver. Additional sensors may be located along the brake line to output signals indicative of brake fluid pressure at various locations along the hydraulic brake line. Other sensors may be provided near the wheel 14 and output signals indicative of wheel speed and braking pressure applied at wheel 14. In the case where at least a portion of the braking system 12 is driven by an electric motor, the controller may control current and voltage supplied to the motor, as well as receive signals indicative of torque, speed, and position of the motor. While each of the sensors referred to above relate to certain aspects of the brake system, any number of sensors may be disposed at additional locations of the brake system to output signals representative of other aspects of brake system performance. Moreover, data may be acquired from other vehicle subsystems to assess performance of vehicle components according to additional aspects of the present disclosure.

The controller 16 is further in communication with an on-board transceiver 18 to transmit data to off-board devices that are remote from the vehicle. The transceiver 18 may be configured to transmit at least a portion of acquired data to an off-board processor via a wireless network. In one example a cellular network including tower 20 is used to relay a wireless signal to and from a server 22.

The server 22 exchanges data with the vehicle 10 using an off-board transceiver 24. The server 22 also includes an off-board processor 26 for performing computer executable instructions. The server 22 further includes a memory 28 that stores data 30 which characterizes expected performance of at least one remote components. The data 30 are indicative of performance of the remote components during a plurality of known operating conditions. The memory 28 also stores one or more applications 32 having instructions executable to perform control actions in response to data received from the remote component. As discussed in more detail below, data is acquired and grouped into data vectors to facilitate off-board processing and statistical analysis. The server may be programmed to compare any number of data vectors received from a remote component with predetermined performance signatures.

The applications 32 may also include algorithms representing mathematical models of various physical aspects of performance of the remote component. In one example the remote component is the brake system 12 of the vehicle 10 and the one or more applications 32 assess the performance and state of health of the braking system. Mathematical models of brake system 10 operation may be used to predict system performance and compare the predictions against actual performance. Model-based assessments of system health may be performed using baseline mathematical models. That is, data received from the controller 16 may be recognized to exemplify certain signature system behaviors associated with component degradation or imminent failure.

The controller 16 is also programmed to condition data acquired at the vehicle prior to transmitting the data to the off-board processor 26. The raw signal data received from various components and/or sensors of the vehicle is converted to feature data sets which are representative of system performance during a drive event. The feature data sets may comprise parameter estimations, state estimations, or deviations between measured values and model estimates. More specifically, the feature data sets may be derived from at least: 1) combinations of multiple data signals, 2) statistical representations of raw signal data over predetermined time periods (e.g., mean, median, variance, etc. of raw signal data), 3) mathematical transformations applied to raw signal data to facilitate data processing (e.g. normalization, mean shifting, or logarithmic transformations), and/or 4) deviations between raw signal data measured values and model-based estimates.

Deviation values, or a difference between measured outputs of the remote components and the model-based estimate outputs, should be close to zero under ideal operating conditions. In the case of a fault, one or more process behaviors will differ from the model-based behavior since the models are structured to mimic fault-free cases. Which signals to use to create deviations may be determined using transfer functions or using state-space formulations for example. The deviation types may be selected such that the deviation values are only influenced by particular fault types that are desired to be detected. The deviations may vary continuously related at least to fluctuations in output raw data and modeling error. To overcome the fluctuations and error, features of the deviation raw data are derived to remove the influence of noise as well as reduce the overall data burden. Depending on the difficulty of detecting a particular fault, the associated deviation may be calculated at a unique sample rate and/or have a unique sensitivity relative to other deviation types associated with different fault types. In some examples thresholds against which the deviations are compared may be adaptive thresholds. That is, a threshold may be automatically adjusted based on the character of the input data (e.g., rate of change of input data, direction of trend of input data, shape of change function of input data). Generally the arrangement of deviations is selected to make the deviations sensitive to faults and at the same time robust against disturbing effects.

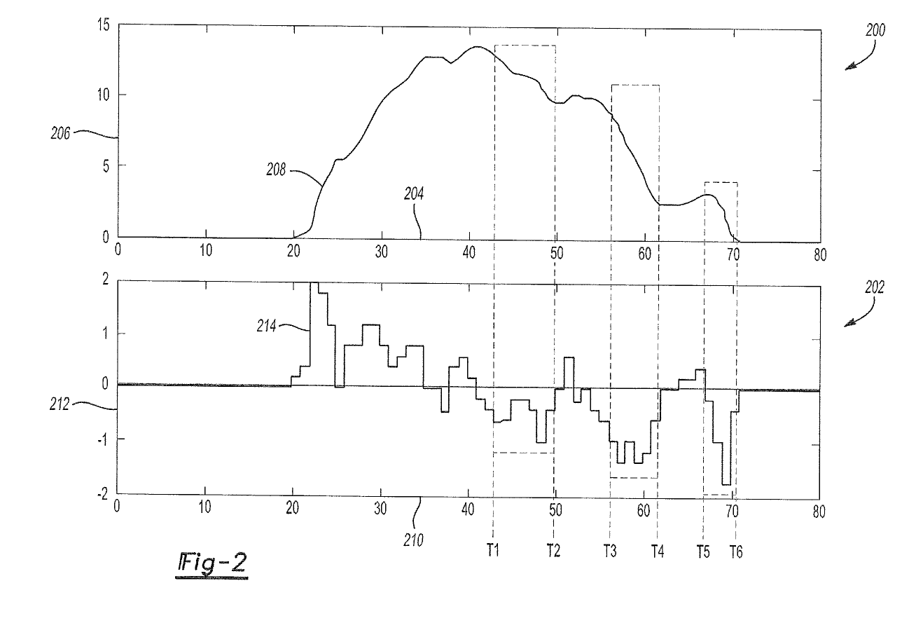

Referring to FIG. 2, plots 200 and 202 correspond in time and are indicative of an example of detecting a vehicle performance event. Plot 200 depicts speed versus time for a segment of drive cycle. Horizontal axis 204 represents time, vertical axis 206 represents vehicle longitudinal speed, and curve 208 represents an example speed profile during a portion of a drive cycle. Plot 202 depicts vehicle acceleration over the same time period as plot 200. Horizontal axis 210 represents time, vertical axis 212 represents acceleration, and curve 214 represents an acceleration profile during the same portion of the drive cycle.

A controller may be programmed to detect vehicle performance events based on monitoring raw signal data. Features are extracted from the signal data, associated with a performance event class, and then transmitted to an off-board processor. In the example of FIG. 2, the performance event is a vehicle driving maneuver. More specifically, the example vehicle driving maneuver is a braking event. The controller may detect initiation of a braking event by observing a reduction in vehicle speed and/or negative acceleration values. In response to detecting the braking event, the controller may undergo a process to collect and store data that is relevant to the braking event. After activating the data collection process at the beginning of a braking event, a data vector is iteratively updated according to the acquired data. At the end of the braking event, the data vector is frozen and recorded in a data buffer at the vehicle and is no longer altered during the remaining duration of the ignition cycle. Each new braking event may trigger the generation of a new data vector. The size of the stored data is largely reduced because only one vector is collected for each event as opposed to storing all raw data spanning over the entirety of each vehicle maneuver.

According to the example of FIG. 2, the controller detects a braking event and begins to update a data vector at time T1. The initiation of the braking event is denoted by both the decrease in vehicle speed as illustrated by curve 208, as well as the negative acceleration value illustrated by curve 214. The controller may also determine the conclusion of the braking event for example by a cessation of the vehicle speed decrease, which also corresponds to substantially zero acceleration. In the case of FIG. 2, a first braking event occurs between time T1 and time T2. The controller uses this event determination as start and stop indices for monitoring vehicle braking parameters. As discussed above the controller monitors raw data signals which are selected as being relevant to one or more particular types of performance events. Feature data sets are generated based on the raw signal data which are representative of system performance during the performance event (i.e., the first braking event) between time T1 and T2. At the conclusion of the event, the feature data set is stored in a data buffer at the vehicle for subsequent use.

Multiple data vectors may be accrued over the course of a drive cycle having a plurality of performance events. With continued reference to FIG. 2, additional braking events are detected based on vehicle velocity and acceleration values later in the drive cycle. Each of the additional braking events includes different deceleration rates and may be classified as unique classes of braking events. A second data vector is generated including the braking data for the duration of time between T3 and T4 representing a second braking event. Similarly, a third data vector is generated for braking data for the duration of time between T5 and T6 representing a third braking event. As can be seen from the plots, each braking event exhibits unique deceleration magnitudes and/or durations, and thus may be classified as different vehicle maneuver class based on different rates of change of vehicle movement. That is, vehicle braking severity may be used to distinguish different classes of braking events. Based on the braking event class, expected brake system component performance may be compared with a predetermined performance signature of the particular braking event class.

While braking events are discussed by way of example, additional types of performance events may also be detected where a controller monitors data signals pertinent to the event during event occurrence. Moreover, the performance events may be indicative of operation of a number of different types of remote components. For example, at least traffic flow monitors, weather pattern monitors, biometric monitors, aviation monitors, and manufacturing system monitors each may include a local device having a controller in communication with a remote processor. The controller may be programmed to monitor data signals pertinent to performance of the particular type of local device. The controller may also generate a feature data set from the data signals. The controller may further assign a performance event classification to the event based on one or more particular performance parameters. The controller may further compile the feature data set and the performance event classification as a data vector. The controller may further temporarily store one or more data vectors in a data buffer at the local device. The controller may further transmit the one or more data vectors to an off-board processor either periodically, or in response to the data buffer being substantially full.

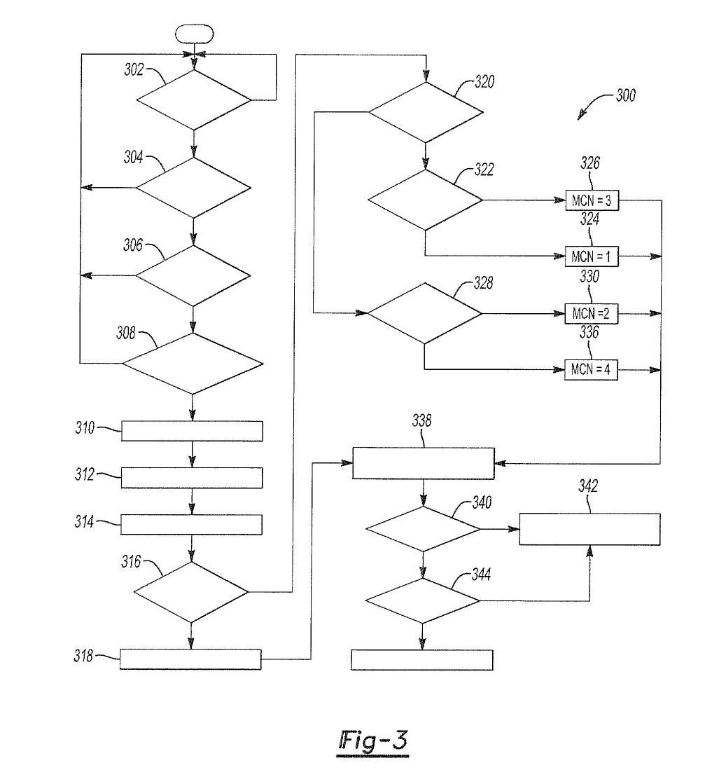

Referring to FIG. 3, method 300 depicts an algorithm for acquiring and transmitting data representative of a vehicle performance event. A braking event is used by way of example, but it should be appreciated that the method may be applied to various other types of vehicle performance events. At step 302 the controller detects a braking event based on at least one of braking demand, vehicle speed, and vehicle acceleration. The controller then assesses any vehicle conditions prerequisite for generating one or more data vectors representative of braking performance. For example, at step 304 the controller assesses whether vehicle velocity is greater than a velocity threshold, V_{X,TH}. If at step 304 the velocity is not greater than the velocity threshold (i.e., Vₓ ≯ V_{X,TH}), the controller may return to the start of method 300 and continue to monitor for the initiation of another braking event.

If at step 304 the velocity is greater than the velocity threshold (i.e., V_{X}>V_{X,TH}), the controller assesses at step 306 whether the brake system has been activated for longer than a predetermined time threshold Y. If at step 306 the brake system has not been activated for longer than the predetermined time threshold Y, the controller may return to the start of method 300 and continue to monitor for the initiation of another braking event.

If at step 306 the brake system has been active for longer than time threshold Y, the controller assesses at step 308 whether other braking-related override functions are active. For example active safety systems such as anti-lock braking systems, automatic traction control systems, and electronic stability control systems may override braking system activations and create operating conditions outside of normal operation. These operating conditions can skew a braking system performance assessment as they may not be representative of actual braking system performance. More specifically, such active safety systems may cause braking system components to activate with behaviors outside of standard operating conditions. If at step 308 a vehicle active safety system involving the brake system is active, the controller may return to the start of method 300 and continue to monitor for the initiation of another braking event.

If at step 308 active safety systems involving the brake system are inactive, the controller sets a data collection flag to “true” at step 310. During data collection the controller monitors raw signal data associated with the brake system during the braking event. The particular signals monitored are selected to be indicative of performance of the brake system and also highlight any degradation of system components. In alternate examples concerning different subsystems, signals characteristic of the particular subsystem performance are selected for monitoring.

At step 312 the controller generates a feature data set based on the monitored raw signal data. As discussed above, the feature data set may include at least transformations, combinations, filtering, and/or normalizations of the raw signal data. The feature data set is indicative of the performance of at least one component of the brake system.

At step 314 the controller initializes a procedure to identify a vehicle maneuver class based on a rate of change of vehicle movement. That is, the controller is programmed to classify the vehicle maneuver into one of a plurality of predefined maneuvers. The controller may store a database of different maneuvers that are characterized by vehicle acceleration conditions. For example, each of normal, hard, and emergency braking may operate to separate classification levels based on applied braking pressure. Also each of straight line, moderate curvature, and hard cornering may also operate to further separate classification levels based on the degree of lateral curvature. Ideal component operating states are known in advance and are stored such that the controller may recall the maneuver class number that is most representative of the present vehicle acceleration conditions.

At step 316 the controller assesses the driver braking intention DBI, which represents how aggressively and urgently the brakes are applied. In one example, DBI is based on brake pedal conditions as described in equation (1) below.

DBI=min(Pos_{pd,norm}, P_{in,norm}) (1)

where POS_{pd,norm} is a normalized brake pedal position, and P_{in,norm} is a normalized brake pedal input pressure as defined by equations (2) and (3), respectively.

Pos_{pd,norm}=Pos_{pd}/P_{pd,max} (2)

P_{in,norm}=Pᵢₙ/P_{in,max} (3)

The normalized brake pedal position Pos_{pd,norm} is a ratio of the current brake pedal position Pos_{pd} to the maximum brake pedal position Pos_{pd,max}. Similarly, the normalized brake pedal input pressure P_{in,norm} is a ratio of current input pressure Pᵢₙ to a maximum input pressure P_{in,max}. Each of the ratios generally carries a value between zero and one. The lesser of the two ratios is used to asses braking intentions and generate a DBI value. As discussed above, braking intention may also be determined automatically by an on-board processor and/or an off-board processor as opposed to driver input at a pedal. In this case other variables may be used to develop a representative value for braking intention.

At step 316 the controller compares DBI to predetermined low threshold. If at step 316 DBI is not greater than a first predetermined threshold (i.e., DBI ≯ DBI_{th,low}), there may not be sufficient braking demand to classify the vehicle maneuver as a known braking event. At step 318 the maneuver classification may be assigned a value of MCN=0, corresponding to substantially zero braking. At step 338 the feature set and MCN associated with the maneuver are stored as a data vector.

If at step 316 DBI is greater than the first predetermined threshold (i.e., DBI>DBI_{th,low}), the controller assesses whether the driver braking intention is greater than a predetermined high threshold. If at step 320 DBI is not greater than a second predetermined threshold (i.e., DBI ≯ DBI_{th,high}), the driver braking intention may be classified in a moderate braking range or considered “normal” braking. During such moderate braking the controller also assesses the degree of curvature through which the vehicle travels. Lateral curvature may be measured by a steering angle sensor, an accelerometer, or other sensor type capable of outputting a signal indicative of lateral vehicle movement. Travelling along curvature while braking may affect the expected performance of various vehicle components. If at step 322 the vehicle is travelling along a substantially straight line path, the maneuver may be assigned a value of MCN=1 at step 324, corresponding to the vehicle undergoing normal or moderate braking along a straight line path.

If at step 322 the vehicle is traveling along a laterally curved path, the maneuver may be assigned a value of MCN=3 at step 324, corresponding to the vehicle undergoing normal braking during cornering. While the present disclosure describes as an example a binary selection between “straight line” travel and “curved” travel, it should be appreciated that any number of segmented curvature ranges may be suitable to classify and distinguish between maneuvers based on various degrees of curvature of vehicle travel during braking.

If at step 320 DBI is greater than a second predetermined threshold (i.e., DBI>DBI_{th,high}), the driver braking intention may be classified in a high braking range or considered “hard” braking. During hard braking the controller also considers the degree of curvature of travel as discussed above. If at step 328 the vehicle is travelling along a substantially straight line path, the maneuver may be assigned a value of MCN=2 at step 330, corresponding to the vehicle undergoing hard braking along a straight line path.

If at step 328 the vehicle is traveling along a laterally curved path, the maneuver may be assigned a value of MCN=4 at step 336, corresponding to the vehicle undergoing hard braking during cornering. Similar to the description above regarding curvature classification, degree of braking may also be divided into additional sub-groups beyond merely “no braking,” “normal braking,” and “hard braking.” A greater number of classifications of the individual parameters may allow for more precision in maneuver classification categories.

Once a maneuver classification number is determined at any of steps 318, 326, 324, 330, or 336, the feature data set and assigned MCN value are stored as a data vector at step 338. A number of data vectors each pertaining to a particular drive event is stored in a memory at the vehicle. The data vectors may be stored in a data buffer as they are generated during a drive cycle. The controller may be programmed to monitor the amount of data stored in the data buffer. If at step 340 the data buffer is substantially full, the controller may transmit the data vectors to an off-board processor or server at step 342. Alternatively, there may be a predetermined size threshold for the data buffer above which the controller may be triggered to perform an upload of the stored data vectors.

If at step 340 the data buffer is not substantially full, the controller assesses whether the drive cycle is complete. At step 344 if the drive cycle is still ongoing, the controller returns to step 302 to continue to monitor for the occurrence of a next drive event during the drive cycle. If the drive cycle is complete at step 344, the controller uploads the data vectors to the off-board server at step 342.

In some examples, a rate of change of the driver braking intention DBIᵣₐₜₑ is also used to determine a maneuver class number. DBIᵣₐₜₑ may indicate the degree of urgency under which braking is required. For example, a value for DBIᵣₐₜₑ above a rate threshold (i.e., DBIᵣₐₜₑ>DBI_{th,rate}) may automatically trigger an “emergency braking” classification and an assignment of corresponding MCN emergency braking value. In another example, a value for DBIᵣₐₜₑ of substantially zero may indicate a hold condition such as a vehicle standstill, or a no braking condition. Depending on the vehicle velocity and other factors, the controller assigns a corresponding MCN value based at least in part on the rate of change of the vehicle braking intention. In a further example, a negative value for DBIᵣₐₜₑ may indicate a release of the brakes, which may correspond to an upcoming conclusion of a braking event. In this case, the controller may assign an MCN value that is based at least in part on a negative rate of change of the vehicle braking intention.

While vehicle braking intention is described with reference to a driver input at a brake pedal, it should be appreciated that in alternative examples, different inputs besides human driver input may determine the braking intention. More specifically, in the case of a self-driving autonomous vehicle one or more vehicle controllers may automatically determine braking demand. In this case the braking intention and rate of change thereof may be a direct output from the processor which controls vehicle propulsion.

The server may use the feature data sets and MCN values received from the vehicle to perform prognosis for one or more vehicle components. In some examples the server makes a comparison of received vehicle data and performance event class values against predetermined performance signatures for the same performance event class. In this way, the server may make prognostic determinations about component state of health, including for example forecasting degraded performance and estimating remaining useful life. Additionally, changes in occurrence frequency of certain performance event classes may also indicate a change in component health. In once example, an increase in the occurrence of events within a “hard braking” event class may signal brake system component degradation.

The server may also store instructions executable to perform a control action in response to one or more data vectors differing from predetermined performance signature by more than a threshold value. Comparison of the data vectors against the predetermined performance signatures may indicate one or more fault conditions. Once a particular fault signature is identified, the server may tailor a unique response depending on the fault type, severity, and immanency of a full failure. The server may cause recording of a diagnostic code. The server may issue a prognosis message indicative of state of health of vehicle components. In one example, the server may cause a message to be displayed at the vehicle to inform the driver of component state of health. In some examples, a multi-tiered prognosis message group may include a general warning level to bring attention to the state of health of a degraded brake system component. The multi-tiered prognosis message group may also include an urgent warning level to inform the driver and/or service provider of an imminent component failure. For example, the server may cause an urgent warning message to be displayed at the vehicle such that the driver is notified of a condition requiring vehicle service. Depending on the urgency of the message, notifications may also be sent to a user mobile device or to a vehicle service provider.

The processes, methods, or algorithms disclosed herein can be deliverable to, and/or implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a brake system configured to resist vehicle movement; and
at least one controller programmed to
detect an initiation of a braking event,
monitor raw signal data associated with the brake system during the braking event,
generate a feature data set based on the raw signal data that is indicative of performance of at least one component of the brake system,
identify a vehicle maneuver class based on a rate of change of vehicle movement,
store the feature data set and the identified vehicle maneuver class as a data vector, and
transmit the data vector to a processor.

2. The vehicle of claim 1 wherein the controller is further programmed to transmit the data vector to an off-board processor in response to a conclusion of a drive cycle.

3. The vehicle of claim 1 wherein the controller is further programmed to store multiple data vectors in a data buffer at the vehicle and transmit at least one of the multiple data vectors to the off-board processor in response to the data buffer being substantially full.

4. The vehicle of claim 1 wherein the vehicle maneuver class is an integer value representing one of a plurality of predetermined vehicle maneuvers.

5. The vehicle of claim 1 wherein the controller is further programmed to receive a prognosis message based on a comparison between the data vector and a predetermined performance signature associated with the identified vehicle maneuver class.

6. The vehicle of claim 1 wherein the vehicle maneuver class is further based on at least one of: a vehicle braking intention, a rate of change of the vehicle braking intention, and vehicle steering angle.

7. The vehicle of claim 1 wherein the controller is further programmed to store a feature data set in response to a conclusion of the braking event.

8. A method of transmitting vehicle data comprising:
in response to detecting an initiation of a driving maneuver, monitoring raw signal data from at least one vehicle component;
generating a feature data set based on the raw signal data that is indicative of performance of the at least one vehicle component during the driving maneuver;
identifying a vehicle maneuver class based on a rate of change of vehicle movement;
storing the feature data set and the identified vehicle maneuver class as a data vector; and
transmitting the data vector to an off-board processor.

9. The method of claim 8 further comprising comparing the data vector to a predetermined performance signature of the identified maneuver class.

10. The method of claim 8 wherein identifying the vehicle maneuver class is further based on at least one of: a vehicle braking intention, a rate of change of the vehicle braking intention, and a vehicle steering angle.

11. The method of claim 8 further comprising storing the data vector in a data buffer at the vehicle and transmitting the data vector to the off-board processor in response to the data buffer being substantially full.

12. The method of claim 8 further comprising not monitoring the raw data signal data while no drive maneuver is detected.

13. The method of claim 8 wherein at least a portion of the feature data set comprises a running average of the raw signal data over a predetermined duration of time.

14. The method of claim 8 wherein transmitting the data vector to an off-board processor is performed in response to at least one of: a conclusion of the driving maneuver, the beginning of an ignition cycle, and the end of an ignition cycle.

15. A data acquisition system comprising:
an off-board server; and
an on-board controller in communication with at least one component, the controller programmed to
detect an initiation of a performance event,
monitor raw signal data associated with the at least one component during the performance event,
generate a feature data set based on the raw signal data that is indicative of performance of the at least one component,
identify a performance event class based on a performance attribute,
store the feature data set and the identified performance event class as a data vector, and
transmit the data vector to the off-board server.

16. The system of claim 15 wherein the controller is further programmed to transmit the data vector in response to a conclusion of a drive cycle.

17. The system of claim 15 wherein the controller is further programmed to store multiple data vectors in a data buffer at an on-board memory and transmit at least one of the multiple data vectors to the server in response to the buffer being substantially full.

18. The system of claim 15 wherein the on-board controller is disposed at a vehicle, the performance event is a vehicle maneuver, and the performance event class is a vehicle maneuver class.

19. The system of claim 15 wherein the server stores instructions executable to compare the data vector with a predetermined performance signature associated with the identified performance event class.

20. The system of claim 15 wherein the server stores instructions executable to send a prognosis message to the on-board controller based on a comparison between the data vector and a predetermined performance signature associated with the identified vehicle maneuver class.
